(19) United States
(12) Patent Application Publication
(10) Pub. No.: US 2018/0227628 A1
(43) Pub. Date: Aug. 9, 2018

(54) Entertainment Center Technical Configuration and System and Method for Use of Same

(71) Applicant: Enseo, Inc., Richardson, TX (US)

(72) Inventors: William C. Fang, Plano, TX (US); Vanessa Ogle, Fairview, TX (US)

(21) Appl. No.: 15/887,833

(22) Filed: Feb. 2, 2018

Related U.S. Application Data
(60) Provisional application No. 62/455,819, filed on Feb. 7, 2017.

(51) Int. Cl. H04N 21/442; H04N 21/45; H04N 21/214; H04N 21/422

(52) U.S. Cl. CPC H04N 21/442; H04N 21/4524; H04N 21/42204; H04N 21/214; H04N 21/4516

(57) ABSTRACT

An entertainment center technical configuration and system and method for use of the same are disclosed. In one embodiment of the system, a set-top box located in a room at a hospitality establishment executes a technical protocol to make the set-top box with a connected display ready for use, and sends an installation quality assurance signal relative to the execution of the technical protocol. A remote receives the installation quality assurance signal from the set-top box and establishes installation quality assurance of the room based on the installation quality assurance signal. Contemporaneously with the execution of the technical protocol, the server receives from a proximate wireless-enabled interactive programmable device located within the room, images of a unique identifier of the room, a unique identifier of the set-top box, a physical connection between the set-top box and the display. These images are utilized to establish physical quality assurance of the room.

### PRIORITY STATEMENT & CROSS-REFERENCE TO RELATED APPLICATIONS

This application claims priority from co-pending U.S. Application No. 62/455,819, entitled “Entertainment Center Technical Configuration and System and Method for Use of Same”, filed on Feb. 7, 2017, in the names of William C. Fang et al.; which is hereby incorporated by reference for all purposes.

### TECHNICAL FIELD OF THE INVENTION

This invention relates, in general, to entertainment centers and, in particular, to entertainment center technical configurations concerning installation, maintenance, and repair configurations, for example, and systems and methods for use of the same that assist an operator with technical tasks.

### BACKGROUND OF THE INVENTION

Without limiting the scope of the present invention, the background will be described in relation to entertainment centers having televisions in the hospitality lodging industry, as an example. During hotel entertainment center installation processes, which includes television and set-top box installation, operators keep track of the progress and problems, if any, of the configuration manually. Such record keeping is difficult and prone to errors. Moreover, unresolved errors may result in multiple trips to the same location to completely troubleshoot a problem. As a result of limitations in existing technology, installation and configuration of televisions and set-top boxes is a frequent complaint and source of aggravation to installation operators and supervisors. Accordingly, there is a need for improved systems and methods for installing entertainment centers, including televisions and set-top boxes.

### SUMMARY OF THE INVENTION

It would be advantageous to introduce systems and methods that further the completion of technical tasks—and other installation, maintenance, and repair tasks—in hospitality lodging establishments and other transitory establishments to ensure completion of the tasks and reduce failure. It would also be desirable to enable a computer-based solution that would mitigate the dependency and issues with manually logged and manually verified installations, maintenance, and repair tasks. To better address one or more of these concerns, an entertainment center technical configuration and system and method for use of the same are disclosed. In one embodiment of the system, a set-top box located in a room at a hospitality establishment executes a technical protocol to make the set-top box with a connected display ready for use, and sends an installation quality assurance signal relative to the execution of the technical protocol.

A remote receives the installation quality assurance signal from the set-top box and establishes installation quality assurance of the room based on the installation quality assurance signal. Contemporaneously with the execution of the technical protocol, the server receives from a proximate wireless-enabled interactive programmable device located within the room, images of a unique identifier of the room, a unique identifier of the set-top box, a physical connection between the set-top box and the display. These images are utilized to establish physical quality assurance of the room. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing entertainment center technical configuration according to the teachings presented herein;

FIG. 2A is a schematic diagram depicting one embodiment of the system of FIG. 1 within an on-property deployment;

FIG. 2B is a schematic diagram depicting one embodiment of the system of FIG. 1 within a cloud-computing deployment;

FIG. 3A is a wall-facing exterior elevation view of one embodiment of the set-top box depicted in FIG. 1 in further detail;

FIG. 3B is a television-facing exterior elevation view of the set-top box depicted in FIG. 2A;

FIG. 3C is a front perspective view of a dongle depicted in FIG. 1 in further detail;

FIG. 4 is a functional block diagram depicting one embodiment of the set-top box presented in FIGS. 3A and 3B;

FIG. 5 is a functional block diagram depicting one embodiment of the proximate wireless-enabled interactive programmable device presented in FIG. 1;

FIG. 6 is a functional block diagram depicting one embodiment of a server presented in FIGS. 2A and 2B;

FIG. 7 is a flow chart depicting one embodiment of a method for providing entertainment center technical configuration according to the teachings presented herein; and

FIG. 8 is a flow chart depicting another embodiment of a method for providing entertainment center technical configuration according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

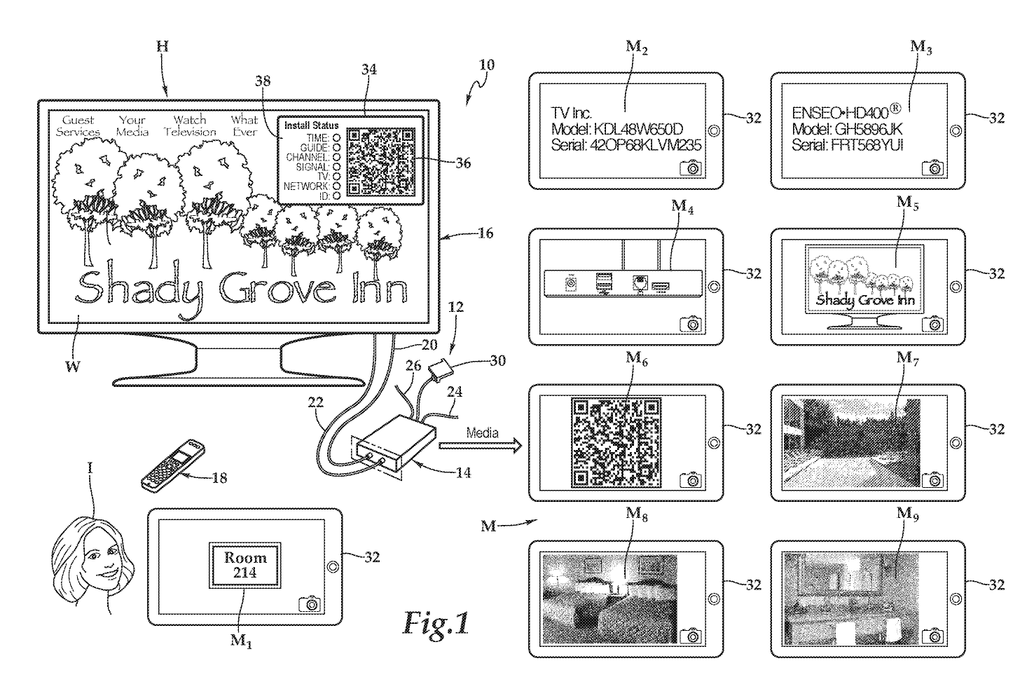

Referring initially to FIG. 1, therein is depicted one embodiment of a system 10 for providing entertainment center technical configuration with a hospitality lodging establishment to an entertainment center 12. The hospitality lodging establishment or, more generally, hospitality property, may be a furnished multi-family residence, dormitory, lodging establishment, hotel, hospital, or other multi-unit environment. As shown, by way of example and not by way of limitation, the hospitality environment is depicted as a hotel H having various rooms and spaces. The entertainment center 12 includes a set-top box 14, which is communicatively disposed with various amenities associated with the hospitality environment, including a display 16. As shown, the display 16 is depicted as a television. It should be appreciated however, that the display 16 may also be any electronic visual display device, for example. Entertainment centers, like the entertainment center 12, may be deployed throughout the rooms and spaces of the hotel H. The entertainment center 12 is depicted as including the set-top box 14, the display 16, and a remote control 18. It should be appreciated however that the entertainment center 12 may include any combination of electronic appliances, components, and devices and, in particular, any combination of electronic appliances, components, and devices found in a hospitality environment.

As shown, with respect to the set-top box 14 and the display 16, a connection, which is depicted as an HDMI connection 20, connects the set-top box 14 to the display 16. Other connections include a power cable 22 coupling the set-top box 14 to a power source, a coaxial cable 24 coupling the set-top box 14 to an external cable source, and a category five (Cat 5) cable 26 coupling the set-top box 14 to an external pay-per-view source at a hotel or other lodging establishment, for example. As shown, the set-top box 14 may include a dongle 30 providing particular technology and functionality extensions thereto. That is, the set-top box 14 may be a set-top box-dongle combination in one embodiment. More generally, it should be appreciated that the cabling connected to the set-top box 14 will depend on the environment and application, and the cabling connections presented in FIG. 1 are depicted for illustrative purposes. Further, it should be appreciated that the positioning of the set-top box 14 will vary depending on environment and application and, with certain functionality, the set-top box 14 may be placed more discretely behind the display 16. Moreover, it should be appreciated that the set-top box 14 and the display 16 may be at least partially or fully integrated.

The television remote control 18 includes an array of buttons for adjusting various settings such as television channel and volume and for providing various inputs during the installation, maintenance, or repair of the set-top boxes and the display 16, as discussed in more detail hereinbelow. In one embodiment, the television remote control 18 may be a consumer infrared (IR), Bluetooth or other wireless-protocol-based device configured as a small wireless handheld object that issues commands from a distance to the set-top box 14 in order to control the display 16 via the set-top box 14, for example.

A proximate wireless-enabled interactive programmable device 32 may be a device, including handheld devices, that may be supplied or carried by the guest and may be selected from a range of existing devices, such as, for example iPads®, iPhones®, iPod Touch®, Android® devices, Blackberry® devices, personal computers, laptops, tablet computers, smart phones, and smart watches, for example. As will be discussed in further detail hereinbelow, the proximate wireless-enabled interactive programmable device 32 is utilized by an installation technician I to execute an application providing a user interface guiding the installation technician I on the installation process.

In one operational embodiment, by way of an application, the proximate wireless-enabled interactive programmable device 32 provides step-by-step installation instructions to the installation technician I while prompting the installation technician I to use the camera and/or video functionality of the proximate wireless-enabled interactive programmable device 32 to document the work with pictures and/or video. The installation technician I is prompted to take a picture of the door M₁ of the room at the beginning of the installation to provide for a physical quality check of the location of the installation technician I. In one embodiment, the proximate wireless-enabled interactive programmable device 32 then prompts the installation technician I to capture media, which may be a photograph of video, of the model and serial number of the display 16 as shown by media M₂. Similarly, the installation technician I is prompted to capture media M₃ of the model and serial number belonging to the set-top box 14. Following the establishment of physical connections between the components of the entertainment center 12, such as the set-top box 14 and the display 16, the installation technician I, following the instructions of the application on the proximate wireless-enabled interactive programmable device 32, captures media M₄ of the physical connections between the set-top box 14 and the display 16, for example.

The entertainment center 12 executes a technical protocol to make the various entertainment center 12 components, including the set-top box 14, the display 16, and the remote control 18 ready for use. The installation technician I captures media M₅ of the welcome screen W of the display as a physical quality check. In operation, in one embodiment, the set-top box 14 is able to automatically download software applications, upload software and update content packages, for example. Tracking and installation progress and reporting the trouble items may also be automated by using the hotel network and network connections beyond the hotel, including connections that interact with a cloud server such that information, including substantially real-time information, can be accessed by any members of the installation team and managers.

As the technical configuration, including the installation progresses, a technical status portal 34 may be shown on the display 16 and include a machine-readable optical label 36, which may be a Quick Response (QR) code, for example. The diagnostic and troubleshooting functions of the set-top box 14 also may generate the human-readable visual labels 38, which may correspond to the machine-readable optical label 36. Both may include specific diagnostic information about the technical protocol, which may relate to installation, maintenance, or repair, for example. The machine-readable optical label 36 may derived from a bitmask such as little Endian.

Both the machine-readable optical label 36 and the human-readable visual labels 38 may be continuously updated throughout the installation or maintenance or repair process in order to provide the installer or technician with a visual indication of the status and, when necessary, a machine-readable optical code which may be captured and shared via a mobile device, for example, with a remote system for verification or troubleshooting purposes. It should be appreciated that any number or configuration of technical status icons may be presented, including an entire screen of technical status icons or a scrolling feature allowing a defined space to provide many sheets of informative technical status icons. As shown, following the execution of the technical protocol by the set-top box 14, the application loaded on the proximate wireless-enabled interactive programmable device or, alternatively, the application available via the Internet, for example, prompts the technical installer to capture media M₆ of the machine-readable optical label 36.

As presented herein, the same installation, maintenance, and repair information that is typically uploaded or transmitted through a network may be reported directly to the television screen for the technician to view and, optionally, capture via a mobile device as described in further detail hereinbelow. That is, as presented herein, in one embodiment, the set-top box may be considered as having a technical widget functionality that automates functions to be performed during installation, maintenance, and repair.

Moreover, at the same time, the set-top box may self-perform various tests on critical aspects of the set-top box and television. The real-time reports which are generated may be transmitted through the hotels infrastructure or alternatively, captured on the television screen in the form of a machine-readable optical label, thereby creating a second, alternative or backchannel of communication for redundant communication during a technical task, such as installation, maintenance, or repair.

In one embodiment, following the application on the proximate wireless-enabled programmable device 32 guiding the installation technician I through the technical protocol to make the entertainment center 12 ready for use and establishing media relative to the physical quality check, the application on the proximate wireless-enabled programmable device 32 prompts the installation technician I to capture media relative to guest room spaces to establish the furnishing and amenities in the room. By way of example, the proximate wireless-enabled interactive programmable device 32 prompts the installation technician I to capture images of the view from the room, media M₇, the bed or beds in the room, media M₈, and the bathroom, media M₉. It should be appreciated that the teachings presented herein not only apply to installation but maintenance, repair, and other technical tasks as well.

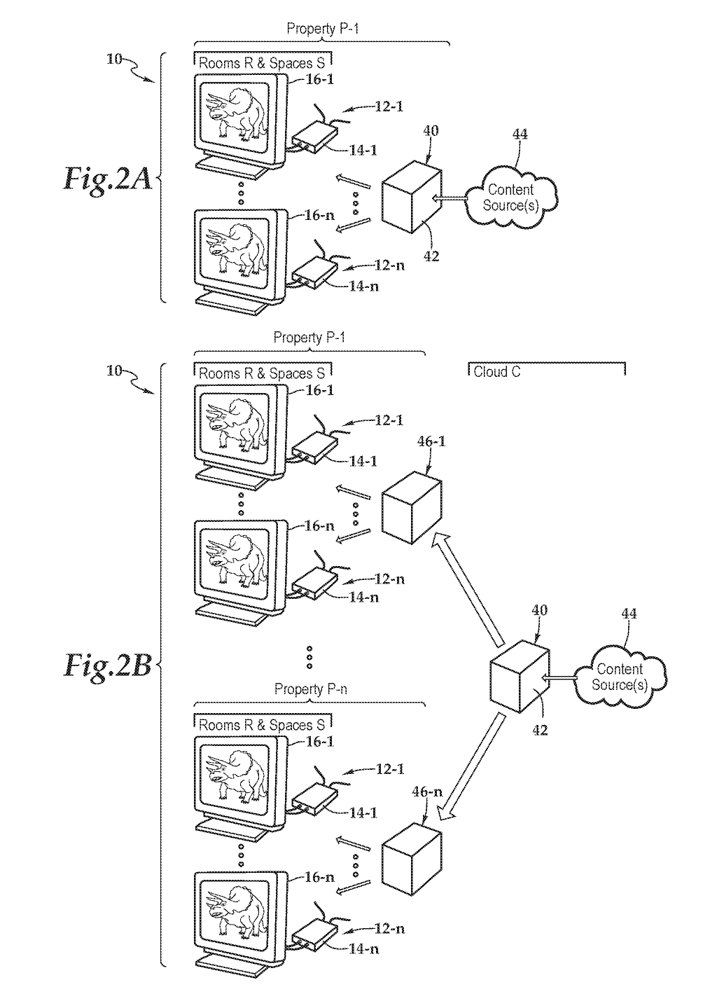

With reference to FIG. 2A and 2B, in one embodiment, the set-top box 14 sends an installation quality assurance signal relative to the execution of the technical protocol. A remote server 40 receives the installation quality assurance signal from the set-top box 14 and establishes installation quality assurance of the room based on the installation quality assurance signal. As mentioned, substantially contemporaneously with the execution of the technical protocol, the server 40 receives from the proximate wireless-enabled interactive programmable device 32 located within the room, images of a unique identifier of the room M₁, a unique identifier of the display M₂, a unique identifier of the set-top box M₃, a physical connection between the set-top box and the display M₄, the welcome screen on the display M₅, and the machine-readable optical label M₆. These images, media M₁ through M₆, are utilized to establish physical quality assurance of the room. Furthermore, substantially contemporaneously with the execution of the technical protocol, the server 40 receives from the proximate wireless-enabled interactive programmable device 32 located within the room, images of the view from the room, media M₇, the bed or beds in the room, media M₈, and the bathroom, media M₉. These images, media M₇ through M₉, are utilized to remotely establish the furnishing and amenities in the room and create a virtual interactive experience with the room.

It should be appreciated that the server 40 may be located on a single property to serve one or more televisions thereon. Further, it should be appreciated that the server 40 may be remotely located to serve multiple properties having multiple televisions. Referring now to FIG. 2A, the system 10 may be deployed such that the server 40 is co-located on the property P-1 with the entertainment centers 12-1 . . . 12-n, with, in one embodiment, content sources 44 configured to provide sources of content. As shown, each of the entertainment centers 12-1 . . . 12-n may respectively include set-top boxes 14-1 . . . 14-n and displays 16-1 . . . 16-n. As shown, the server 40 includes a housing 42 having a television output and other components therein.

Referring to FIG. 2B, the system 10 may be deployed such that the server 40 is located remotely within cloud C relative to the entertainment centers 12-1 . . . 12-n, which are located at properties P-1 through P-n. As shown, each of the entertainment centers 12-1 . . . 12-n may respectively include set-top boxes 14-1 . . . 14-n and displays 16-1 . . . 16-n. In particular, the server 40, which receives content from content sources 44, may be located remotely relative to the entertainment centers 12-1 . . . 12-n such that a property headend 46-1 . . . 46-n is interposed between the server 40 and the entertainment centers 12-1 . . . 12-n. As shown, in this implementation, the property headend 46-1 . . . 46-n is co-located with the entertainment centers 12-1 . . . 12-n at a respective property, P-1 through P-n.

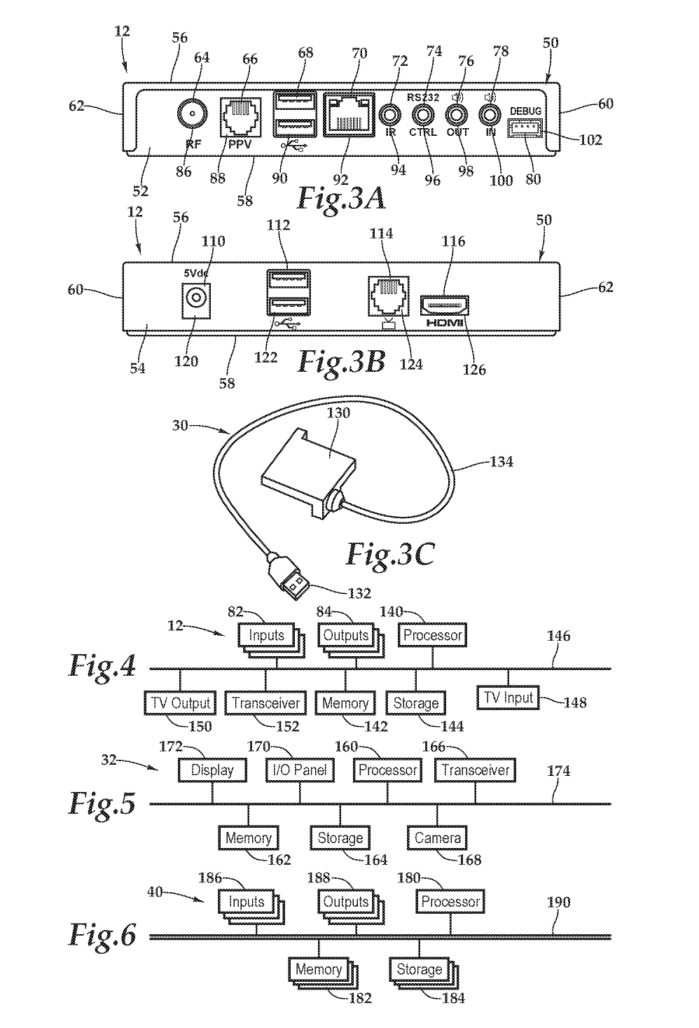

Referring to FIG. 3A, FIG. 3B, FIG. 3C, and FIG. 4, as used herein, set-top boxes, back boxes and set-top/back boxes may be discussed as set-top boxes. By way of example, the set-top box 14 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 14 includes a housing 50 having a rear wall 52, front wall 54, top wall 56, bottom base 58, and two sidewalls 60, 62. It should be appreciated that front wall, rear wall, and side wall are relative terms used for descriptive purposes and the orientation and the nomenclature of the walls may vary depending on application. The front wall includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an RF input 86, a RJ-45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The front wall 54 also includes various inputs 82 and outputs 84. More particularly, ports 110, 112, 114, and 116 include a 5V dc power connection 120, USB inputs/outputs 122, an RJ-45 coupling 124, and an HDMI port 126. It should be appreciated that the configuration of ports may vary with the set-top box depending on application and context. As previously alluded to, the housing 50 may include a housing-dongle combination including, with respect to the dongle 30, a unit 130 having a cable 134 with a set-top box connector 132 for selectively coupling with the set-top box 14.

Within the housing 50, a processor 140, memory 142, storage 144, the inputs 82, and the outputs 84 are interconnected by a bus architecture 146 within a mounting architecture. It should be understood that the processor 140, memory 142, storage 144, the inputs 82, and the outputs 84 may be entirely contained within the housing 50 or the housing-dongle combination. The processor 140 may process instructions for execution within the computing device, including instructions stored in the memory 142 or in storage 144. The memory 142 stores information within the computing device. In one implementation, the memory 142 is a volatile memory unit or units. In another implementation, the memory 142 is a non-volatile memory unit or units. Storage 144 provides capacity that is capable of providing mass storage for the set-top box 12. Various inputs 82 and outputs 84 provide connections to and from the computing device, wherein the inputs 82 are the signals or data received by the set-top box 14, and the outputs 84 are the signals or data sent from the set-top box 14.

A television content signal input 148 and a television output 150 are also secured in the housing 50 in order to receive content from a source in the hospitality property and forward the content, including external content such as cable and satellite and pay-per-view (PPV) programing, to the television located within the hotel room.

A transceiver 152 is associated with the set-top box 12 and communicatively disposed with the bus 146. As shown the transceiver 152 may be internal, external, or a combination thereof to the housing. Further, the transceiver 152 may be a transmitter/receiver, receiver, or an antenna for example. Communication between various amenities in the hotel room and the set-top box 14 may be enabled by a variety of wireless methodologies employed by the transceiver 152, including 802.11, 3G, 4G, Edge, WiFi, ZigBee, near field communications (NFC), Bluetooth low energy and Bluetooth, for example. Also, infrared (IR) may be utilized.

The memory 142 and storage 144 are accessible to the processor 140 and include processor-executable instructions that, when executed, cause the processor 140 to execute a series of operations. The processor-executable instructions cause the processor to execute a technical protocol to make the set-top box and the display ready for use and then may cause the processor to send an installation quality assurance signal relative to the execution of the technical protocol. Also, the processor-executable instructions may include instructions to generate a human-readable visual label that contains information about the status of the technical protocol as well as generate a machine-readable optical label that contains information about the status of the technical protocol, the machine-readable optical label includes diagnostic information for escalated and remote trouble shooting about the status of the technical protocol. The processor-executable instructions may cause the processor to forward, via the television output, the output signal including the human-readable visual label and the machine-readable optical label to the television, and dynamically update the human-readable visual label and the machine-readable optical label as the status of the technical protocol changes.

Referring now to FIG. 5, the proximate wireless-enable interactive programmable device 32 may be a wireless communication device of the type including various fixed, mobile, and/or portable devices. To expand rather than limit the previous discussion of the the proximate wireless-enable interactive programmable device 32, such devices may include, but are not limited to, cellular or mobile telephones, watches, two-way radios, personal digital assistants, digital music players, Global Position System units, and so forth. The the proximate wireless-enable interactive programmable device 32 may include a processor 160, memory 162, storage 164, transceiver 166, a camera 168, I/O panel 170, and a display 172 interconnected by a bus architecture 174. It should be appreciated that although a particular architecture is presented, other designs and layouts are within the teachings presented herein.

In one embodiment, the memory 162 and storage 164 are accessible to the processor 160 and include processor-executable instructions that, when executed, cause the processor 160 to execute a series of operations. The processor-executable instructions cause the processor to execute an application providing a user interface guiding the installation technician on the installation process. An installation procedure and diagrams may be displayed by the application one step at a time to guide the installation process. The application prompts the installation technician to use the camera and/or video to document the work-in-progress and completed with pictures and video at particular points in the process or step-by-step, for example.

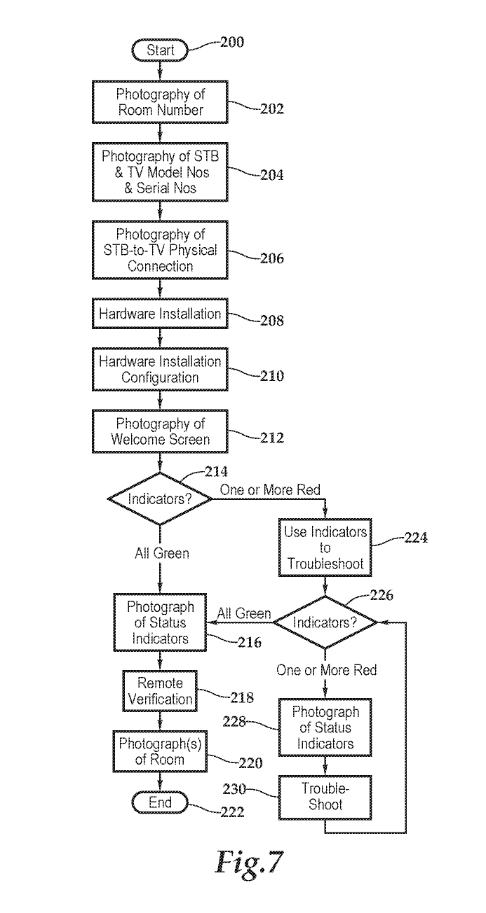

Referring now to FIG. 6, one embodiment of the server 40 as a computing device includes a processor 180, memory 182, storage 184, inputs 186, and outputs 188 interconnected with various buses 190 in a common or distributed, for example, mounting architecture. In other implementations, in the computing device, multiple processors and/or multiple buses may be used, as appropriate, along with multiple memories and types of memory. Further still, in other implementations, multiple computing devices may be provided and operations distributed therebetween. The processor 180 may process instructions for execution within the server 40, including instructions stored in the memory 182 or in storage 184. The memory 182 stores information within the computing device. In one implementation, the memory 182 is a volatile memory unit or units. In another implementation, the memory 182 is a non-volatile memory unit or units. Storage 184 includes capacity that is capable of providing mass storage for the server 40. Various inputs 186 and outputs 188 provide connections to and from the server 40, wherein the inputs 186 are the signals or data received by the server 40, and the outputs 188 are the signals or data sent from the server 40.

The memory 182 and storage 184 are accessible to the processor 180 and include processor-executable instructions that, when executed, cause the processor 180 to execute a series of operations. In one embodiment, the processor-executable instructions cause the processor to receive the installation quality assurance signal from the set-top box prior to establishing installation quality assurance of the room based on the installation quality assurance signal. The processor-executable instructions also cause the processor to, substantially contemporaneously with the execution of the technical protocol to make the set-top box and the display ready for use, receive from a proximate wireless-enabled interactive programmable device located within the room one or more of the following: first media relative to an image of a unique identifier of the room; second media relative to a unique identifier of the set-top box; third media relative to a physical connection between the set-top box and the display; fourth media relative to a unique identifier of the display; fifth media relative to a welcome page on the display; sixth media relative to a machine-readable optical label that contains information about the status of the technical protocol; and seventh media relative to guest room spaces within the room. The processor-executable instructions then cause the processor to establish physical quality assurance of the room based on the first, second, third, fourth, fifth, and sixth media. Further, the processor-executable instructions cause the processor to establish furnishings and amenities in the room based on the seventh media.

Referring now to FIG. 7, one embodiment of a method utilizing entertainment centers and particularly set-top boxes with installation, as an example, within the hospitality lodging industry is depicted. It should be appreciated that the methodology presented herein is also applicable to maintenance and repair as well. At block 200, the methodology is initiated and advanced to block 202 where a photograph of the room number on the door, for example is taken by an installer to remotely establish physical quality assurance. The photograph is forwarded to the remote server. In one implementation, the installation and data collected during the installation is associated with the installer and the quality of the work performed by the installer and the efficiency of the installer, such as time required to install each room and the number of rooms installed per day, may be collected, evaluated, and graphed. At block 204, the model and serial numbers of the components of the entertainment center, including the set-top box and the display, are photographed and the photograph is forwarded to the remote server. At block 206, following the installation technician completing the physical connections within the entertainment center, photographs of the physical connections are captured and the photographs are forwarded to the remote server. At block 208, the hardware installation begins with the various connections of the set-top box and television being completed. At block 210, the installation technician initializes the installation configuration of the set-top box by, in one embodiment, actuating a code on a remote control associated with the set-top box. At block 212, the installation technician is prompted to capture a photograph of a welcome screen on the display to further the remote establishment of physical quality assurance. The photograph is forwarded to the remote server. At decision block 214, as the installation process progresses, the installer views the television screen for the visual indicators, which, in one implementation, light green or red to show progress on several installation protocol items.

If the visual indicator lights are all green, then the methodology advances to block 216, where the installer captures a photograph or image of the machine-readable optical label and forwards the same at block 218 to a verification system, which may be a property server on-site or alternatively, a property management or maintenance server off-site. It should be appreciated that other forms of verification, including communication between any on-site property server or an off-site property management server may also occur with the set-top box as part of the installation process. The transmission of the machine-readable optical code by an alternative route, i.e., mobile device backchannel provides additional verification. At block 220, the technician is prompted to capture images of the room to establish the ammenities and views therein. At block 222, the methodology ends.

Returning to decision block 214, if one or more indicators are red, then the methodology advances to block 224 where the installer uses the indicators to trouble shoot or diagnose the problem. As previously discussed, the indicators may include a QR code, for example, that may be read to provide additional details on the testing, such as functional test results and selftest results. Further, at the block 224, troubleshooting tips may be provided if there are issues. At decision block 226, if following diagnostic action, the indicators are all green, then the flow chart advances to previously discussed block 216. On the other hand, if one or more indicators are still red, then an image or photograph of the machine-readable optical label is captured at block 228 and transmitted at block 230 to provide escalated and remote trouble shooting. As previously discussed, the machine-readable optical label provides diagnostic information, which can be read at the remote location to provide insight into the nature of the problem. Moreover, often during installation and maintenance when issues occur, the set-top box under work may not be in communication with the remote site. Therefore, the methodology presented herein provides an alternative channel of communication of data relevant to the installation issue. Following block 230, the methodology returns to decision block 226.

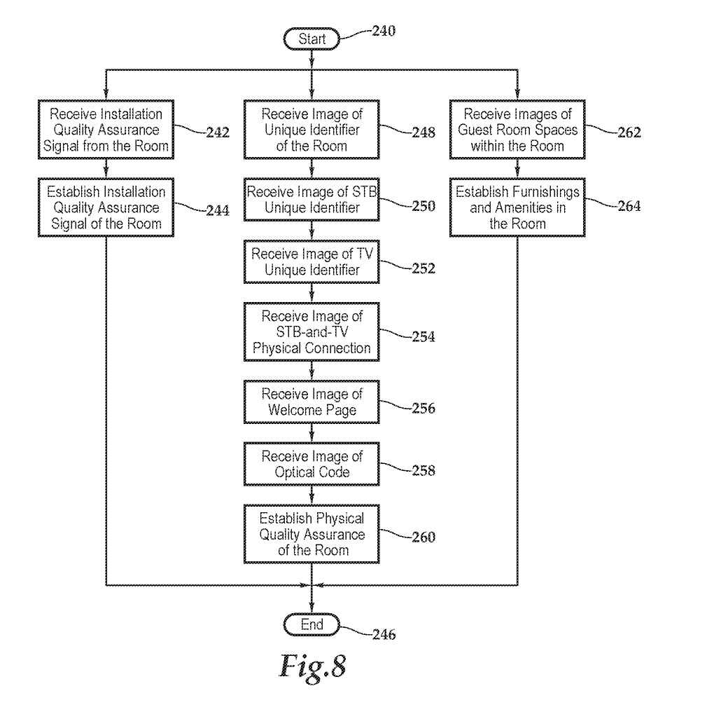

Referring now to FIG. 8, another embodiment of a method for providing entertainment center technical configuration is presented. At block 240, the methodology is initiated and advanced to block 242 where the server receives an installation quality assurance signal from the room via the installer technician and the proximate wireless-enabled interactive programmable device. The installation quality assurance may include, by way of example, at least one task including verifying the room is online; verifying the room has passed a self-test; verifying the room is free of TV connection issues, HDMI connection issues, and TV control connection issues; verifying that the set-top box satisfies RF specifications; verifying that Bluetooth® devices are activated, verifying WiFi devices are activated, and verifying room number match. At block 242, the server utilizes the installation quality assurance signal to establish installation quality assurance in the room. Substantially contemporaneously with the execution of blocks 242 and 244, at block 248, the server receives media, which may be a photograph or video, for example, of a unique identifier, such as a room number on a door, of the room. At blocks 250, 252, 254, 256, and 258, the server respectively receives media relative to a unique identifier of the set-top box, media relative to a unique identifier of the display, media relative to the physical connection between the set-top-box and the display, media relative to a welcome page on the display, and an image of a machine-readable optical label from the display. At block 260, the server utilizes the media captured during blocks 250 through 258 to remotely establish physical quality assurance of the room. At block 246, the methodology ends.

Substantially contemporaneously with the execution of blocks 242 and 244 as well as blocks 248 through 260, at block 262, the server receives media relative to guest room spaces within the room. By way of example and not by way of limitation, the media relative to guest room spaces within the room may include audiovisual media such as bathroom area audiovisual media, dressing area audiovisual media, clothes storage area audiovisual media, sleeping area audiovisual media, work area audiovisual media, entry area audiovisual media, window view audiovisual media, and hallway area audiovisual media. At block 264, the server utilizes the media received at block 262 to establish the furnishing and amenities in the room to create a virtual experience and virtual documentation of the room. At block 246, the methodology ends.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display, and
establish physical quality assurance of the room based on the first, second, and third media.

2. The system as recited in claim 1, wherein the processor-executable instructions of the set-top box further comprise processor-executable instructions that, when executed, cause the processor to:
generate a human-readable visual label that contains information about the status of the technical protocol;
generate a machine-readable optical label that contains information about the status of the technical protocol;
forward, via the television output, the output signal including the human-readable visual label and the machine-readable optical label; and
dynamically update the human-readable visual label and the machine-readable optical label as the status of the technical protocol changes.

3. The system as recited in claim 2, wherein the processor-executable instructions of the server further comprise processor-executable instructions that, when executed, cause the processor to:
receive the machine-readable optical label via an alternative channel of communication upon capturing the machine-readable optical label on the television; and
upon receipt of the machine-readable optical label, read the machine-readable optical label to furnish remote set-top box troubleshooting.

4. The system as recited in claim 1, wherein the processor-executable instructions of the set-top box further comprise processor-executable instructions that, when executed, cause the processor to:
generate a human-readable visual label that contains information about the status of the technical protocol;
generate a machine-readable optical label that contains information about the status of the technical protocol, the machine-readable optical label includes diagnostic information for escalated and remote trouble shooting about the status of the technical protocol;
forward, via the television output, the output signal including the human-readable visual label and the machine-readable optical label to the television; and
dynamically update the human-readable visual label and the machine-readable optical label as the status of the technical protocol changes.

5. The system as recited in claim 4, wherein the processor-executable instructions of the server further comprise processor-executable instructions that, when executed, cause the processor to:
receive the machine-readable optical label via an alternative channel of communication upon capturing the machine-readable optical label on the television; and
upon receipt of the machine-readable optical label, read the machine-readable optical label to furnish remote set-top box troubleshooting.

6. The system as recited in claim 1, wherein the display further comprises a device selected from the group consisting of electronic visual display devices and televisions.

7. The system as recited in claim 1, wherein the set-top box further comprises a wireless transceiver associated with the housing and coupled to the busing architecture.

8. The set-top box as recited in claim 3, wherein the hospitality establishment is selected from the group consisting of furnished multi-family residences, dormitories, lodging establishments, hotels, hospitals, and multi-unit environments.

9. The set-top box as recited in claim 1, wherein the housing further comprises a housing-dongle combination securing the television input, the television output, the processor, memory, and storage.

10. The set-top box as recited in claim 1, wherein the processor and the memory are distributed through the housing-dongle combination.

11. The set-top box as recited in claim 1, wherein the proximate wireless-enabled interactive programmable device comprises a device selected from the group consisting of personal computers, laptops, tablet computers, smart phones, and smart watches.

12. The system as recited in claim 1, wherein the installation quality assurance further comprises at least one task selected from the group consisting of verifying the room is online; verifying the room has passed a self-test; verifying the room is free of TV connection issues, HDMI connection issues, and TV control connection issues; verifying that the set-top box satisfies RF specifications; verifying that Bluetooth® devices are activated, verifying WiFi devices are activated, and verifying room number match.

13. The system as recited in claim 1, wherein the first media further comprises an image of a room number on a door of the room.

14. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive fourth media relative to a unique identifier of the display.

15. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive fifth media relative to a welcome page on the display.

16. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive sixth media relative to a machine-readable optical label that contains information about the status of the technical protocol.

17. The system as recited in claim 1, wherein the processor-executable instructions of the server further comprise processor-executable instructions that, when executed, cause the processor to substantially contemporaneously with the execution of the technical protocol to make the set-top box and the display ready for use, receive from a proximate wireless-enabled interactive programmable device located within the room, receive seventh media relative to guest room spaces within the room.

18. The system as recited in claim 17, wherein the seventh media relative to guest room spaces within the room further comprises audiovisual media of the room selected from the group consisting of bathroom area audiovisual media, dressing area audiovisual media, clothes storage area audiovisual media, sleeping area audiovisual media, work area audiovisual media, entry area audiovisual media, window view audiovisual media, and hallway area audiovisual media.

19. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol, generate a human-readable visual label that contains information about the status of the technical protocol;
generate a machine-readable optical label that contains information about the status of the technical protocol, the machine-readable optical label includes diagnostic information for escalated and remote trouble shooting about the status of the technical protocol,
forward, via the television output, the output signal including the human-readable visual label and the machine-readable optical label to the television, and
dynamically update the human-readable visual label and the machine-readable optical label as the status of the technical protocol changes; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display, receive fourth media relative to a unique identifier of the display, receive fifth media relative to a welcome page on the display, and sixth media relative to a machine-readable optical label that contains information about the status of the technical protocol, and
establish physical quality assurance of the room based on the first, second, third, fourth, fifth, and sixth media.

20. A system for entertainment center technical configuration, the system comprising:
a set-top box located in a room at a hospitality establishment having a plurality of rooms, the set-top box including:
a housing securing a television input, a television output, a processor, memory, and storage therein,
a busing architecture communicatively interconnecting the television input, the television output, the processor, the memory, and the storage,
the television input configured to receive a source signal from an external source,
the television output configured to forward a fully tuned signal to a display, and
the memory accessible to the processor, the memory including processor-executable instructions that, when executed, cause the processor to:
execute a technical protocol to make the set-top box and the display ready for use,
send an installation quality assurance signal relative to the execution of the technical protocol, generate a human-readable visual label that contains information about the status of the technical protocol;
generate a machine-readable optical label that contains information about the status of the technical protocol, the machine-readable optical label includes diagnostic information for escalated and remote trouble shooting about the status of the technical protocol,
forward, via the television output, the output signal including the human-readable visual label and the machine-readable optical label to the television, and
dynamically update the human-readable visual label and the machine-readable optical label as the status of the technical protocol changes; and
a server located remote to the room, the server including:
a housing securing inputs, outputs, a processor, memory, and storage therein,
a busing architecture communicatively interconnecting the inputs, outputs, the processor, the memory, and the storage, and
the memory accessible to the processor, the memory including processor-executable instructions that, when executed, cause the processor to:
receive the installation quality assurance signal from the set-top box,
establish installation quality assurance of the room based on the installation quality assurance signal,
substantially contemporaneously with the execution of the technical protocol to make the set-top box and the display ready for use, receive from a proximate wireless-enabled interactive programmable device located within the room, first media relative to an image of a unique identifier of the room, second media relative to a unique identifier of the set-top box, and third media relative to a physical connection between the set-top box and the display, receive fourth media relative to a unique identifier of the display, receive fifth media relative to a welcome page on the display, sixth media relative to a machine-readable optical label that contains information about the status of the technical protocol, receive seventh media relative to guest room spaces within the room,
establish physical quality assurance of the room based on the first, second, third, fourth, fifth, and sixth media, and
establish furnishings and amenities in the room based on the seventh media.
